(19) United States
(12) Patent Application Publication
(10) Pub. No.: US 2022/0324732 A1
(43) Pub. Date: Oct. 13, 2022

(54) A PORTABLE WATER ELECTROMAGNETIC DE-IONIZER

(71) Applicant: WEISMACHER ECO PRIVATE LIMITED, Ahmedabad, Gujarat (IN)

(72) Inventors: Rajeshkumar Hariprasad ACHARYA, Ahmedabad, Gujarat (IN); Yusuf Nazmuddin GHADIALI, Ahmedabad, Gujarat (IN)

(21) Appl. No.: 17/640,605

(22) PCT Filed: Sep. 2, 2020
(86) PCT No.: PCT/IN2020/050766

§ 371 Date: Mar. 4, 2022

(30) Foreign Application Priority Data
Sep. 4, 2019 (IN) 201921035641

(51) Int. Cl. C02F 1/48

(52) U.S. Cl. CPC C02F 1/485; C02F 2201/483

(57) ABSTRACT

The present invention relates to a portable water de-ionizer including a vertically elongated tubular housing for receiving a water container, i.e., a bottle being filled with water to be treated and a base being anchored to the bottom end of housing. The tubular housing is provided with a coil being circumferentially wound on the outer surface thereof to form a plurality of turns. Further, the base accommodates a SMPS circuit for providing a required voltage supply to the coil. The bottle filled with the water is placed within the tubular housing. The electronic circuit is electrically connected to the coil wound around the tubular housing and communicates a succession of radio frequency signals to the coil that create an electromagnetic field in water filled within the tubular housing. The electronic field continuously de-ionizes the water filled in the bottle while the bottle is placed within the tubular housing.

### FIELD OF INVENTION

The present invention relates to a water de-ionizer and more particularly it relates a portable water electromagnetic de-ionizer that is easy to carry and install and effectively de-ionize the water.

### BACKGROUND OF INVENTION

In today era, the most common way for people to de-ionize water at home, is by using a water de-ionizing machine. These machines are attached to your main source of water, such as your kitchen tap. Depending on the model you have, you will be able to set the specific pH levels that you want the water to be. The electric water ionizers utilize small voltages of electricity to change the electrical charge of the water molecules. Water ionizers tend to be expensive.

In the process of treating water so that it becomes drinkable, water treatment facilities often add chemicals and filters to remove unhealthy molecules from the water. One side effect of this process is that some of the hydrogen molecules become negatively charged. Charged water will have an unbalanced pH level, and living organisms, including humans, are sensitive to pH levels. By ionizing water, you can restore the natural pH balance to the water that you drink.

One such water de-ionizing system is disclosed in U.S. Pat. No. 3,661,775 that disclosing 3-bed ion exchange water deionization system. The first bed contains a strongly acidic cation exchange resin; the second bed contains a weakly basic anion exchange resin; and the third bed contains a strongly basic anion exchange resin. Water to be deionized is passed down through the first column. The effluent is divided into two parts, the major portion being made to pass down through the second or weakly basic resin and, eventually, through the third column containing the strongly basic resin. The minor portion of the effluent from the cation exchange bed is mixed together with the effluent from the weakly basic resin bed and then sent down through the strongly basic resin bed. The effluent from the third column or strongly basic resin bed is the deionized water.

Moreover, water deionization system is also disclosed in WO02/098798 that disclosing a system, and a method for at least partially deionizing water, including but not limited to converting tap water into essentially deionized water that can be used for numerous purposes including, but not limited to cleaning and/or treating surfaces, including surfaces such as ceramic, steel, plastic, glass and/or painted surfaces such as the exterior surface of a vehicle, is disclosed.

Another method of treating water that has become popular over the past several years has been to de-ionize water. Water de-ionizing can be accomplished with specially designed ceramic beads and/or electrolysis machines to separate out high pH water from low pH water. Low pH, acidic water is generally considered good for cleaning and disinfecting, while high pH, alkaline water is desirable for drinking, as it more effectively creates anti-oxidant rich water to flush out acidic compounds in the body and micro clusters of water molecules which are absorbed more readily by the body and facilitate absorption of minerals and nutrients.

Subsequently, another method for treating water is developed by using Electro-magnetic systems. The electromagnetic systems work in a similar manner to magnetic systems, however some of the electro magnetic systems include oscillation of the magnetic field to offset the permanent polarization effect. However, such magnetic effect only works for short lineal pipe sections and therefore the system only partially acts on the water that is passing through the section of the pipe and a greater water velocity results in a less effective magnetic system for treating scale.

Hence, the need exists for development of water deionizer that constantly ionizes the water.

### OBJECT OF INVENTION

The main object of the present invention is to provide a portable water electromagnetic de-ionizer that is east to carry and install.

Another object of the present invention is to provide a portable water electromagnetic de-ionizer that obviates the difficulties associated with the conventional water de-ionizer systems.

### SUMMARY OF INVENTION

The present invention relates to portable water de-ionizer comprising vertically elongated tubular housing for receiving water container i.e. bottle being filled with water to be treated and a base being anchored with bottom end of housing. Said tubular housing is provided with coil being circumferentially wound on the outer surface thereof to form a plurality of turns. Further, said base accommodates SMPS circuit for providing required voltage supply to the coil. The bottle filled with the water is placed within the tubular housing. Said electronic circuit is electrically connected to the coil wound around the tubular housing and communicates a succession of radio frequency signals to coil that create an electromagnetic field in water filled within the tubular housing. Said electronic field continuously ionized the water filled in the bottle while the bottle is placed within the tubular housing.

### BRIEF DESCRIPTION OF DRAWINGS

Object and advantages of the invention will be apparent from the following detailed description taken in conjunction with the accompanying FIGURE of the drawing wherein:

FIG. 1 illustrates a schematic view of the portable water electromagnetic de-ionizer according to present invention.

### DETAILED DESCRIPTION OF INVENTION

The nature of the invention and the manner in which it works is clearly described in the complete specification. The invention has various embodiments and they are clearly described in the following pages of the complete specification. Before explaining the present invention, it is to be understood that the invention is not limited in its application.

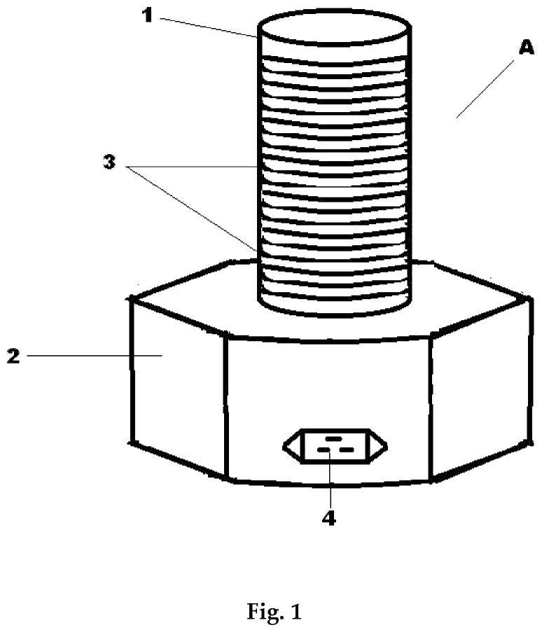

Now as shown in FIG. 1, a portable water electromagnetic de-ionizer (A) according to present invention comprises, but not limited to, a vertically elongated tubular housing (1) for receiving water container i.e. bottle being filled with the water to be treated and a base (2) having a hollow interior and being anchored with bottom end of the housing (1).

Referring continuous with FIG. 1, said tubular housing (1) is provided with coil (3) being circumferentially wound on the outer surface thereof to form a plurality of turns. Further, said base (2) accommodates the SMPS circuit in the hollow interior for providing required voltage supply to the coil (3). Said base (2) is provided with socket (4) for providing auxiliary voltage supply to the SMPS circuit. It is to be understood that the battery may also be used for providing voltage supply of required ratings.

In operation, the bottle filled with the water is placed within the tubular housing (1). Said electronic circuit is electrically connected to the coil wound around the tubular housing (1) and communicates a succession of radio frequency signals to the coil (3) that create an electromagnetic field in the water filled in the bottle placed within the tubular housing (1). Said electronic field continuously de-ionized the water filled in the bottle while the bottle is placed within the tubular housing (1). Here, the water is de-ionized continuously as water is in static condition rather than flowing condition so that the water gets enough time to be de-ionized. Further, said arrangement is easy to assemble, carry and install at any place.

The invention has been explained in relation to specific embodiment. It is inferred that the foregoing description is only illustrative of the present invention and it is not intended that the invention be limited or restrictive thereto. Many other specific embodiments of the present invention will be apparent to one skilled in the art from the foregoing disclosure. All substitution, alterations and modification of the present invention which come within the scope of the following claims are to which the present invention is readily susceptible without departing from the spirit of the invention. The scope of the invention should therefore be determined not with reference to the above description but should be determined with reference to appended claims along with full scope of equivalents to which such claims are entitled.

### LIST OF REFERENCE NUMERALS

Housing (1)
Base (2)
Coil (3)
Socket (4)

1. A portable water electromagnetic de-ionizer comprising:
a tubular housing for receiving a water container; and
a base having a hollow interior, wherein the base is anchored to a bottom end of the tubular housing;
wherein said tubular housing is vertically elongated and comprises a coil circumferentially wound on an outer surface thereof to form a plurality of turns; and
wherein said base accommodates a switch mode power supply (SMPS) circuit in the hollow interior for providing voltage to the coil.

2. The portable water electromagnetic de-ionizer according to claim 1, wherein said base further comprises a socket for providing an auxiliary voltage supply to the SMPS circuit.

3. A process of deionizing water using the portable water electromagnetic de-ionizer according to claim 1, said process comprising the following steps:
a) placing a water container containing water within the tubular housing;
b) supplying power to the coil wound on the outer surface of the tubular housing through the SMPS circuit;
c) generating a succession of radio frequency signals in the coil that create an electromagnetic field on the water container placed within the tubular housing; and
d) de-ionizing the water in the water container through the electromagnetic field while the water container is placed within the tubular housing.
